(19) United States
(12) Patent Application Publication
(10) Pub. No.: US 2024/0233317 A9
(43) Pub. Date: Jul. 11, 2024

(54) LUMINARY MEASUREMENT SYSTEM AND METHOD

(71) Applicant: HTC Corporation, Taoyuan City (TW)

(72) Inventor: Chao Shuan Huang, Taoyuan City (TW)

(73) Assignee: HTC Corporation, Taoyuan City (TW)

(21) Appl. No.: 18/491,792

(22) Filed: Oct. 22, 2023

Related U.S. Application Data
(60) Provisional application No. 63/419,282, filed on Oct. 25, 2022.

(51) Int. Cl. G06V 10/60; G06T 7/62; G06T 7/70; G06T 7/80; G06V 10/74

(52) U.S. Cl. CPC G06V 10/60; G06T 7/62; G06T 7/70; G06T 7/80; G06V 10/761

(57) ABSTRACT

A luminary system is provided. The luminary measurement system includes a processor and a camera. The camera is configured to obtain an object image of an object. The object includes a first luminary and a second luminary. The processor is configured to determine a first position of the first luminary and a second position of the second luminary based on the object image. The processor is configured to determine whether the first position and the second position are correct or not based on standard alignment information.

### CROSS-REFERENCE TO RELATED APPLICATION

This application claims the priority benefit of U.S. provisional application Ser. No. 63/419,282, filed on Oct. 25, 2022. The entirety of the above-mentioned patent application is hereby incorporated by reference herein and made a part of this specification.

### BACKGROUND

### Technical Field

The disclosure relates to a luminary measurement system; particularly, the disclosure relates to a luminary measurement system and a luminary measurement method.

### Description of Related Art

A luminary is an object that emits lights and may be used individually or in combination with other luminaries to form a luminary array. A luminary array is a group of luminaries that are arranged in a specific pattern. The luminary array can be used for a variety of purposes, including: illumination, decoration, communication, education. That is, luminary array are a versatile and creative way to use light. The luminary array may be used for a variety of purposes, from decoration to illumination to communication.

### SUMMARY

The disclosure is direct to a luminary measurement system and a luminary measurement method, so as to provide an intuitive and convenient way to perform an inspection to the luminary array.

In this disclosure, a luminary measurement system is provided. The luminary measurement system includes a processor and a camera. The camera is configured to obtain an object image of an object. The object includes a first luminary and a second luminary. The processor is configured to determine a first position of the first luminary and a second position of the second luminary based on the object image. The processor is configured to determine whether the first position and the second position are correct or not based on standard alignment information.

In this disclosure, a luminary measurement method is provided. The luminary measurement method includes: obtaining an object image of an object, wherein the object comprises a first luminary and a second luminary; determining a first position of the first luminary and a second position of the second luminary based on the object image; and determining whether the first position and the second position are correct or not based on standard alignment information.

Based on the above, according to the luminary measurement system and the luminary measurement method, not only the time required for measurement is reduced, but also the accuracy of measurement is increased.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a luminary measurement system according to an embodiment of the disclosure.

FIG. 2 is a schematic diagram of a luminary measurement scenario according to an embodiment of the disclosure.

FIG. 3 is a schematic diagram of a luminary measurement scenario according to an embodiment of the disclosure.

FIG. 4 is a schematic diagram of a luminary measurement scenario according to an embodiment of the disclosure.

FIG. 5 is a schematic flowchart of a luminary measurement method according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

It should be noted that in the following embodiments, the technical features of several different embodiments may be replaced, recombined, and mixed without departing from the spirit of the disclosure to complete other embodiments. As long as the features of each embodiment do not violate the spirit of the disclosure or conflict with each other, they may be mixed and used together arbitrarily.

A luminary is an object that emits lights and may be used individually or in combination with other luminaries to form a luminary array. A luminary array is a group of luminaries that are arranged in a specific pattern. The luminary array can be used for a variety of purposes, including: illumination, decoration, communication, education. That is, luminary array are a versatile and creative way to use light. The luminary array may be used for a variety of purposes, from decoration to illumination to communication.

After the luminary array is manufactured, in order to check the quality of the luminary array, it is necessary to perform an inspection to the workpiece including the luminary array. Traditionally, the inspection may be performed by measuring, one by one, a luminance of each of the luminaries in the luminary array through a sensor, such as an integrating sphere or a photo diode. However, while using the integrating sphere or the photo diode for measurement, the integrating sphere or the photo diode must be carefully aligned with each of the luminaries in the luminary array. For example, if a position of the integrating sphere or the photo diode is shifted or tilted relative to the object to be measured, the measurement result may be inaccurate. Therefore, it is the pursuit of people skilled in the art to provide an intuitive and convenient way to perform an inspection to the luminary array.

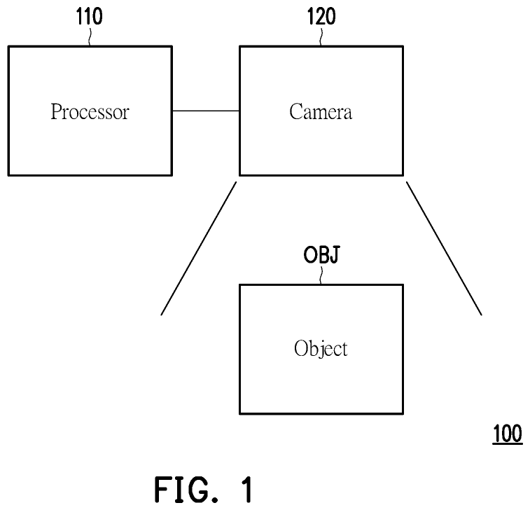

FIG. 1 is a schematic diagram of a luminary measurement system according to an embodiment of the disclosure. With reference to FIG. 1, a luminary measurement system 100 may include a processor 110 and a camera 120 coupled to the processor 110. The camera 110 may be configured to obtain an object image of an object OBJ. It is noted that, the object OBJ may include a first luminary and a second luminary. Further, the processor 110 may be configured to determine a first position of the first luminary and a second position of the second luminary based on the object image. Moreover, the processor 110 may be configured to determine whether the first position and the second position are correct or not based on standard alignment information.

In one embodiment, the object OBJ may include a luminary array and the luminary array may include the first luminary and the second luminary. Further, the standard alignment information may be pre-stored in a memory of the luminary measurement system 100, and the standard alignment information may include an accurate alignment, luminance, or size of each of the luminaries in the luminary array. For example, the standard alignment information may include a first standard position of the first luminary, and the processor 110 may be configured to compare the first position with the first standard position to determine whether the first position is correct or not. Further, the standard alignment information may include a first standard luminance of the first luminary and the processor 110 may be configured to compare the first luminance with the first standard luminance to determine whether the first luminance is correct or not. Furthermore, the standard alignment information may include a first standard size of the first luminary and the processor 110 may be configured to compare the first size with the first standard size to determine whether the first luminance is correct or not. That is, the standard alignment information may include an alignment, luminance, or size of a golden sample corresponding to the luminaries in the luminary array. However, this disclosure is not limited thereto.

In one embodiment, a position and/or a size of a luminary may be determined an image recognition algorithm, an object tracking algorithm or a pre-trained model. In one embodiment, a luminance of a luminary may be determined based on a light spot size corresponding to the luminary on the object image. In one embodiment, a central point of a luminary may be determined as a position of the luminary. However, this disclosure is not limited thereto.

It is noted that, since the luminary array is measured by the camera 120 instead of the integrating sphere or the photo diode, the positional relationship between the camera 120 and the luminary array may be more flexible. That is, the camera 120 does not have to be carefully aligned with each of the luminaries in the luminary array as long as the luminary array is in the field of view (FOV) of the camera 120. In other words, an angle between a direction of the camera 120 and a normal line of the object OBJ may be greater than zero. However, an angle between a direction of the camera and a normal line of the object may be equal to zero and is not limited thereto.

In this manner, the luminary array may be measurement in an intuitive and convenient way. Therefore, not only the time required for measurement is reduced, but also the accuracy of measurement is increased.

In one embodiment, the processor 110 may include, for example, a microcontroller unit (MCU), a central processing unit (CPU), a microprocessor, a digital signal processor (DSP), a programmable controller, a programmable logic device (PLD), other similar devices, or a combination of these devices. The disclosure is not limited thereto. In addition, in an embodiment, each of functions of the processor 110 may be achieved as multiple program codes. The program codes are stored in a memory, and executed by the processor 110. Alternatively, in an embodiment, each of the functions of the processor 110 may be achieved as one or more circuits. The disclosure does not limit the use of software or hardware to achieve the functions of the processor 110.

In one embodiment, the camera 120, may include, for example, a complementary metal oxide semiconductor (CMOS) camera, a charge coupled device (CCD) camera, a light detection and ranging (LiDAR) device, a radar, an infrared sensor, an ultrasonic sensor, other similar devices, or a combination of these devices. The disclosure is not limited thereto.

In some embodiments, the luminary measurement system 100 may further include a memory. In one embodiment, the memory may include, for example, NAND flash memory cores, NOR flash memory cores, static random access memory (SRAM) cores, dynamic random access memory (DRAM) cores, magnetoresistive random access memory (MRAM) cores, Phase change memory (PCM) cores, resistive random access memory (ReRAM) cores, 3D XPoint memory cores, ferroelectric random-access memory (FeRAM) cores, and other types of memory cores that are suitable for storing data. However, this disclosure is not limited thereto.

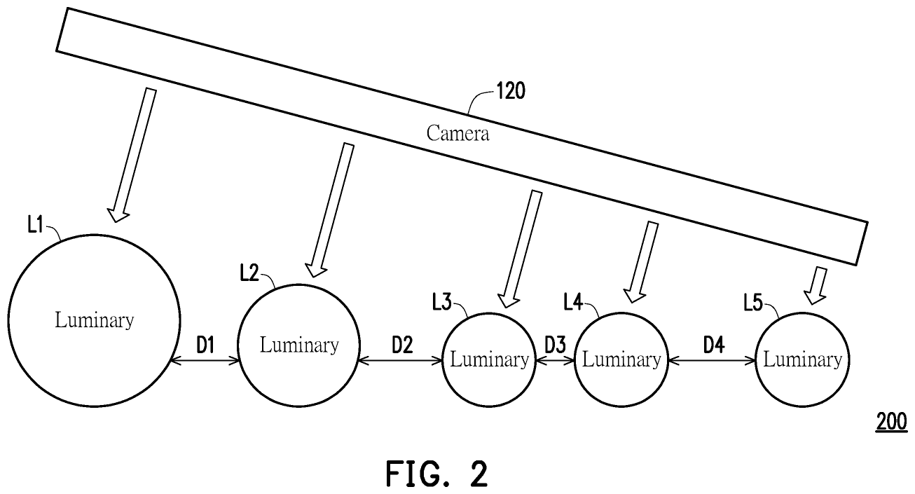

FIG. 2 is a schematic diagram of a luminary measurement scenario according to an embodiment of the disclosure. With reference to FIG. 1 and FIG. 2, a luminary measurement scenario 200 may include the camera 120, a first luminary L1, a second luminary L2, a third luminary L3, a fourth luminary L4, a fifth luminary L5. The first luminary L1, the second luminary L2, the third luminary L3, the fourth luminary L4, the fifth luminary L5 may be included in a luminary array in the object OBJ.

Referring to FIG. 2, the camera 120 may be disposed over the object OBJ, so that the object OBJ may be in the FOV of the camera 120. It is noted that, although it is depicted that the camera 120 is disposed obliquely over the object OBJ, but this disclosure is not limited thereto.

In one embodiment, the camera 120 may be configured to capture an image of the object OBJ to generate the object image. Since the first luminary L1, the second luminary L2, the third luminary L3, the fourth luminary L4, the fifth luminary L5 are in the object OBJ (e.g., on the top surface of the object OBJ), the first luminary L1, the second luminary L2, the third luminary L3, the fourth luminary L4, the fifth luminary L5 may be also be captured in the object image. Based on the object image, the processor 110 may be configured to determine a condition of each of the luminaries of the luminary array is correct or not.

For example, the processor 110 may be configured to determine a distance between each of the luminaries of the luminary array and compare the distance with a standard distance stored in the standard alignment information. As shown in FIG. 2, a distance D1 may be between the first luminary L1 and the second luminary L2, a distance D2 may be between the second luminary L2 and the third luminary L3, a distance D3 may be between the third luminary L3 and the fourth luminary L4, and a distance D4 may be between the fourth luminary L4 and the fifth luminary L5.

If the distance is equal to the standard distance, the distance may be determined as a correct distance. On the other hand, if the distance is not equal to the standard distance, the distance may be determined as an incorrect distance. Under such circumstance, a calibration distance between the distance and the standard distance may be generated and used to adjust the luminaries to the correct distance. That is, the processor 110 may be configured to generate a calibration distance between the first luminary L1 and the second luminary L2 based on the standard alignment information. Furthermore, the luminary measurement system 100 may further include a calibration tool and the calibration tool is configured to adjust a perspective relationship between the camera 120 and the object OBJ. In one embodiment, the calibration tool may be a robotic arm and/or a software algorithm, but this disclosure is not limited thereto. In one embodiment, most of the positions of the luminaries may be correct and only few of the positions of the luminaries are incorrect. That is, a position relationship between most of the luminaries may be used to calculate the perspective relationship between the camera 120 and the object OBJ to compensate the standard alignment information. For example, the perspective relationship can be calculated based on dividing the distance D1 by the D2. In this manner, after an observation position from the camera 120 to the object OBJ being changed, the luminary measurement system 100 may be able to perform the measurement more accurately.

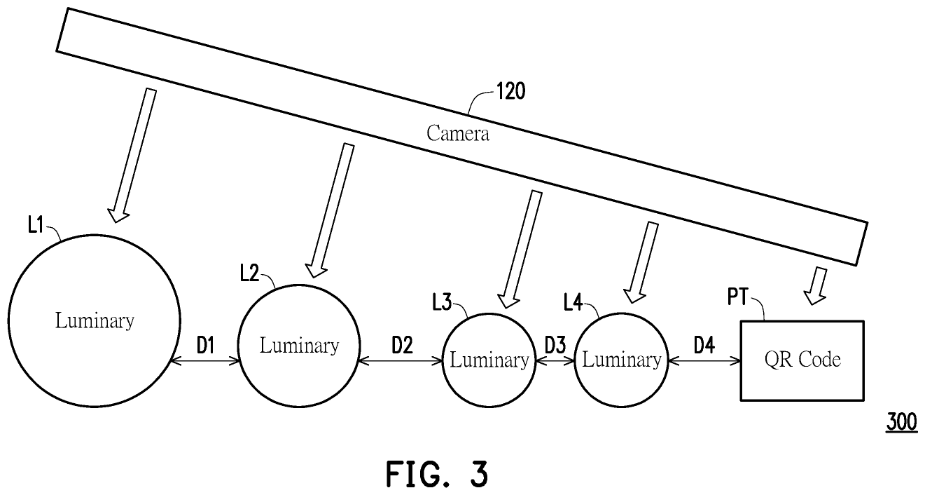

FIG. 3 is a schematic diagram of a luminary measurement scenario according to an embodiment of the disclosure. With reference to FIG. 1 to FIG. 3, a luminary measurement scenario 300 is similar as the luminary measurement scenario 200. The difference between the luminary measurement scenario 200 and the luminary measurement scenario 300 is that the object OBJ may include an information pattern PT. For example, the information pattern PT may be one of a QR code, a barcode, and object information. However, this disclosure is not limited thereto.

It is worth mentioned that, during the manufacture process of the object, a QR code, a barcode, and object information may be attached on the object OBJ for providing information related to the manufacture process. On the other hand, since the object OBJ may be designed for a certain purpose, a QR code, a barcode, and object information may be attached on the object OBJ for providing information related to the certain purpose. That is, there is usually an information pattern attached on the object OBJ. Therefore, instead of adding any additional marker or tracker on the object OBJ, the information pattern may be used as a specific pattern for the image recognition or the object tracking. In other words, the processor 110 may be configured to determine whether the first position and the second position are correct or not based on a standard alignment information and the information pattern. Therefore, the accuracy of measurement may be increased without adding any additional marker or tracker on the object OBJ. In addition, similar as the position relationship between the luminaries, the information pattern PT (e.g., QR code) may be also used to calculate the perspective relationship between the camera 120 and the object OBJ to compensate the standard alignment information, while the details are not redundantly described seriatim herein. In this manner, after an observation position from the camera 120 to the object OBJ being changed, the luminary measurement system 100 may be able to perform the measurement more accurately.

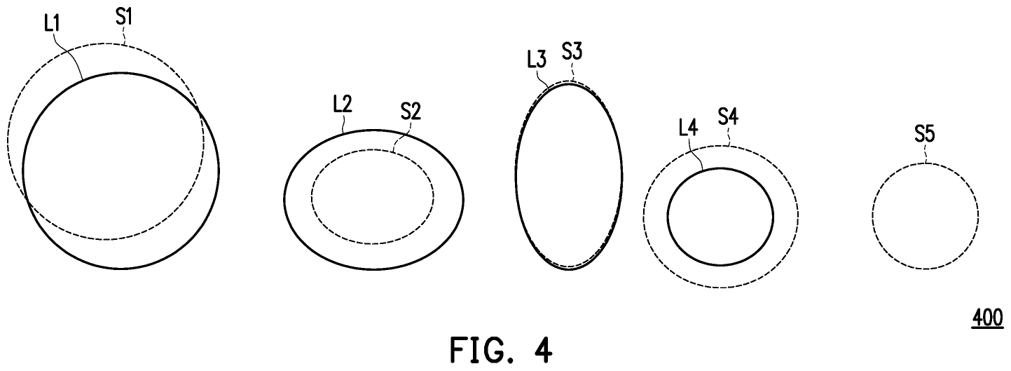

FIG. 4 is a schematic diagram of a luminary measurement scenario according to an embodiment of the disclosure. With reference to FIG. 1 to FIG. 4, a luminary measurement scenario 400 may include the first luminary L1, the second luminary L2, the third luminary L3, and the forth luminary L4. Further, the luminary measurement scenario 400 may include a first standard shape S1, a second standard shape S2, a third standard shape S3, a fourth standard shape S4, and a fifth standard shape S5. Each of the standard shapes may correspond to one of the luminaries of the luminary array.

In one embodiment, a golden sample of the luminary array may include the standard shape S1, the second standard shape S2, the third standard shape S3, the fourth standard shape S4, and the fifth standard shape S5. The standard shapes of the luminaries may be compared with the measurement result for an inspection of the luminary array.

Referring to the first luminary L1 and the first standard shape S1, although sizes and shapes of the first luminary L1 and the first standard shape S1 are the same, positions of the first luminary L1 and the first standard shape S1 are different. That is, a position of the first luminary L1 may be shifted from a position of the first standard shape S1. Thus, the position of the first luminary L1 may be determined as a wrong position and the first luminary L1 may be determined as a wrong luminary.

Referring to the second luminary L2 and the second standard shape S2, although positons of the second luminary L2 and the second standard shape S2 are the same, sizes of the second luminary L2 and the second standard shape S2 or light spot sizes of the second luminary L2 and the second standard shape S2 are different. That is, a size of the second luminary L2 may be greater than a size of the second standard shape S2 or an output power (i.e., the light spot size) of the second luminary L2 may be greater than an output power of the second standard shape S2. Thus, the size or the light spot size of the second luminary L2 may be determined as a wrong size or a wrong light spot size and the second luminary L2 may be determined as a wrong luminary.

Referring to the third luminary L3 and the third standard shape S3, sizes, positions of the third luminary L3 and the third standard shape S3 are exactly the same, That is, a size or position of the third luminary L3 may same as an ideal size or position of the third luminary L3 (i.e., the third standard shape S3). Thus, the size or the position of the third luminary L3 may be determined as a correct size or a correct position and the third luminary L3 may be determined as a correct luminary.

Referring to the fourth luminary L4 and the fourth standard shape S4, although positons of the fourth luminary L4 and the fourth standard shape S4 are the same, sizes of the fourth luminary L4 and the fourth standard shape S4 or light spot sizes of the fourth luminary L4 and the fourth standard shape S4 are different. That is, a size of the fourth luminary L4 may be smaller than a size of the fourth standard shape S4 or an output power (i.e., the light spot size) of the fourth luminary L4 may be smaller than an output power of the fourth standard shape S4. Thus, the size or the light spot size of the fourth luminary L4 may be determined as a wrong size or a wrong light spot size and the fourth luminary L4 may be determined as a wrong luminary.

Referring to the fifth standard shape S5, no luminaries may be identified based on the object image. That is, the fifth luminary may be broken. Thus, the fifth luminary L1 may be determined as a wrong luminary.

Based on the above comparison result, calibration information may be generated. Therefore, a wrong luminary may be corrected manually or automatically based on the calibration information.

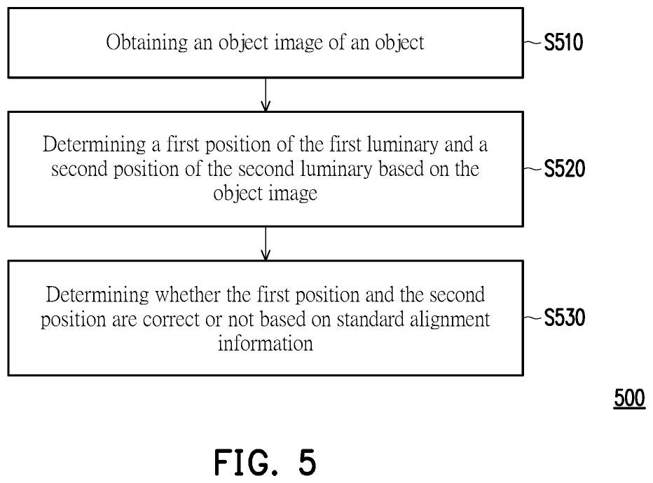

FIG. 5 is a schematic flowchart of a luminary measurement method according to an embodiment of the disclosure. Referring to FIG. 1 to FIG. 5, a luminary measurement method 500 may include a step S510, a step S520, and a step S530.

In the step S510, the object image of the object OBJ may be obtain through the camera 120. The object OBJ may include the first luminary L1 and the second luminary L2. In the step S520, a first position of the first luminary L1 and a second position of the second luminary L2 may be determined based on the object image. In the step S530, whether or not the first position and the second position are correct may be determined based on the standard alignment information.

In addition, the implementation details of the luminary measurement method 500 may be referred to the descriptions of FIG. 1 to FIG. 4 to obtain sufficient teachings, suggestions, and implementation embodiments, while the details are not redundantly described seriatim herein.

In summary, according to the luminary measurement system 100 and the luminary measurement method 500, the luminary array may be measurement in an intuitive and convenient way. Therefore, not only the time required for measurement is reduced, but also the accuracy of measurement is increased.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A luminary measurement system, comprising:
a camera, configured to obtain an object image of an object, wherein the object comprises a first luminary and a second luminary; and
a processor, configured to:
determine a first position of the first luminary and a second position of the second luminary based on the object image; and
determine whether the first position and the second position are correct or not based on standard alignment information.

2. The luminary measurement system according to claim 1, wherein the object comprises a luminary array and the luminary array comprises the first luminary and the second luminary.

3. The luminary measurement system according to claim 1, wherein
the standard alignment information comprises a first standard position of the first luminary, and
the processor is configured to compare the first position with the first standard position to determine whether the first position is correct or not.

4. The luminary measurement system according to claim 1, wherein the standard alignment information comprises a first standard luminance of the first luminary, and
the processor is configured to:
determine a first luminance of the first luminary based on the object image; and
compare the first luminance with the first standard luminance to determine whether the first luminance is correct or not.

5. The luminary measurement system according to claim 1, wherein the standard alignment information comprises a first standard size of the first luminary, and
the processor is configured to:
determine a first size of the first luminary based on the object image; and
compare the first size with the first standard size to determine whether the first size is correct or not.

6. The luminary measurement system according to claim 1, wherein an angle between a direction of the camera and a normal line of the object is greater than zero.

7. The luminary measurement system according to claim 1, wherein an angle between a direction of the camera and a normal line of the object is equal to zero.

8. The luminary measurement system according to claim 1, wherein the processor is configured to generate a calibration distance between the first luminary and the second luminary based on the standard alignment information.

9. The luminary measurement system according to claim 8, further comprising:
a calibration tool, configured to adjust a perspective relationship between the camera and the object based on the first position of the first luminary and the second position of the second luminary to compensate the standard alignment information.

10. The luminary measurement system according to claim 8, wherein
the object comprises an information pattern and the information pattern is one of a QR code, a barcode, and object information, and
the processor is configured to adjust a perspective relationship between the camera and the object based on the information pattern to compensate the standard alignment information.

11. A luminary measurement method, comprising:
obtaining an object image of an object, wherein the object comprises a first luminary and a second luminary;
determining a first position of the first luminary and a second position of the second luminary based on the object image; and
determining whether the first position and the second position are correct or not based on standard alignment information.

12. The luminary measurement method according to claim 11, wherein the object comprises a luminary array and the luminary array comprises the first luminary and the second luminary.

13. The luminary measurement method according to claim 11, wherein the standard alignment information comprises a first standard position of the first luminary, and the luminary measurement method further comprises:
comparing the first position with the first standard position to determine whether the first position is correct or not.

14. The luminary measurement method according to claim 11, wherein the standard alignment information comprises a first standard luminance of the first luminary, and the luminary measurement method further comprises:
determining a first luminance of the first luminary based on the object image; and
comparing the first luminance with the first standard luminance to determine whether the first luminance is correct or not.

15. The luminary measurement method according to claim 11, wherein the standard alignment information comprises a first standard size of the first luminary, and the luminary measurement method further comprises:
determining a first size of the first luminary based on the object image; and
comparing the first size with the first standard size to determine whether the first size is correct or not.

16. The luminary measurement method according to claim 11, wherein an angle between a direction of the camera and a normal line of the object is greater than zero.

17. The luminary measurement method according to claim 11, wherein an angle between a direction of the camera and a normal line of the object is equal to zero.

18. The luminary measurement method according to claim 11, further comprising:
generating a calibration distance between the first luminary of the second luminary based on the standard alignment information.

19. The luminary measurement method according to claim 18, further comprising:
adjusting a perspective relationship between the camera and the object based on the first position of the first luminary and the second position of the second luminary to compensate the standard alignment information.

20. The luminary measurement method according to claim 18, wherein the object comprises an information pattern and the information pattern is one of a QR code, a barcode, and object information, and the luminary measurement method further comprises:
adjusting a perspective relationship between the camera and the object based on the information pattern to compensate the standard alignment information.
